(19) United States
(12) Patent Application Publication
(10) Pub. No.: US 2006/0255060 A1
(43) Pub. Date: Nov. 16, 2006

(54) Method and apparatus for dispensing liquid at a desired flow rate

(76) Inventor: Mark Miller, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 11/406,137

(22) Filed: Apr. 18, 2006

Related U.S. Application Data
(60) Provisional application No. 60/680,160, filed on May 12, 2005.

(51) Int. Cl. B67D 5/08

(52) U.S. Cl. 222/63

(57) ABSTRACT

The present invention relates to a novel method and apparatus for dispensing liquid at a desired flow rate. The flow rate of the liquid is calculated automatically based on the change in weight of liquid in a weigh vessel per time unit. In particular, it relates to a method and apparatus for dispensing agrochemicals. The method and apparatus is of use, inter alia, in seed treatment.

This application claims the benefit of U.S. Provisional Application No. 60/680,160, filed May 12, 2005.

The present invention relates to a novel method and apparatus for dispensing liquid at a desired flow rate. In particular, it relates to a method and apparatus for dispensing agrochemicals. The method and apparatus is of use, inter alia, in seed treatment.

Seed treatment is an important process in the agriculture industry since it helps growers protect their crops from pests such as fungi, insects and nematodes. It therefore helps to maximise crop yield. However, it is important to use good seed treatment technique to ensure good pest control. In particular, this involves applying agrochemicals to seeds in the correct concentration and at the correct rate.

Before they are used, agrochemicals are diluted to a working concentration, usually with water. Often more than one agrochemical is applied to seeds simultaneously. Some conventional seed treatment equipment uses a direct treatment method to dispense multiple agrochemicals. In such seed treatment equipment, agrochemicals are pumped or injected directly into the seed treater and the amount of chemical is measured using one or more mass flow meters.

Other seed treatment equipment works by making a slurry mix of agrochemicals at the desired concentration prior to treatment. The rate at which the slurry mix is pumped into the seed treater is calibrated prior to seed treatment. First, a calibration tube is filled with slurry mix; the slurry mix is then pumped out of the calibration tube for a set time period (for example 30 seconds); the volume of product pumped out of the tube in that time is measured and used to calculate the flow rate manually; the pump speed is adjusted as appropriate; and the process is repeated to check the adjusted flow rate.

This ‘trial and error’ approach to adjusting the flow rate can be time consuming and inaccurate. Further, the flow rate in a seed treater needs to be checked and calibrated at regular intervals to ensure that it remains at the desired level. In order to do this, the calibration process must be repeated.

There is therefore an on-going need for a method of adjusting the flow rate that is quicker and more accurate. Weight is a convenient and accurate parameter for measuring liquids since density is not affected by temperature. The present invention uses a weigh vessel that measures the weight of its contents at frequent time intervals so that a flow rate can be automatically calculated, based on the actual weight of liquid pumped from the weigh vessel per time unit. By outputting the flow rate to a display, it can be easily and accurately adjusted in real time. Further, the flow rate can be monitored continuously while the liquid is being pumped to ensure that it does not deviate from the desired level.

According to the present invention, there is provided a method for dispensing liquid at a desired flow rate, comprising partially or completely filling a weigh vessel with liquid to be dispensed, activating a metering pump to pump the liquid out of the weigh vessel, and adjusting the speed of the metering pump to the desired flow rate, wherein the weigh vessel measures the weight of its contents at least one time per minute, a processing unit converts this information into the flow rate, and a display unit outputs the flow rate.

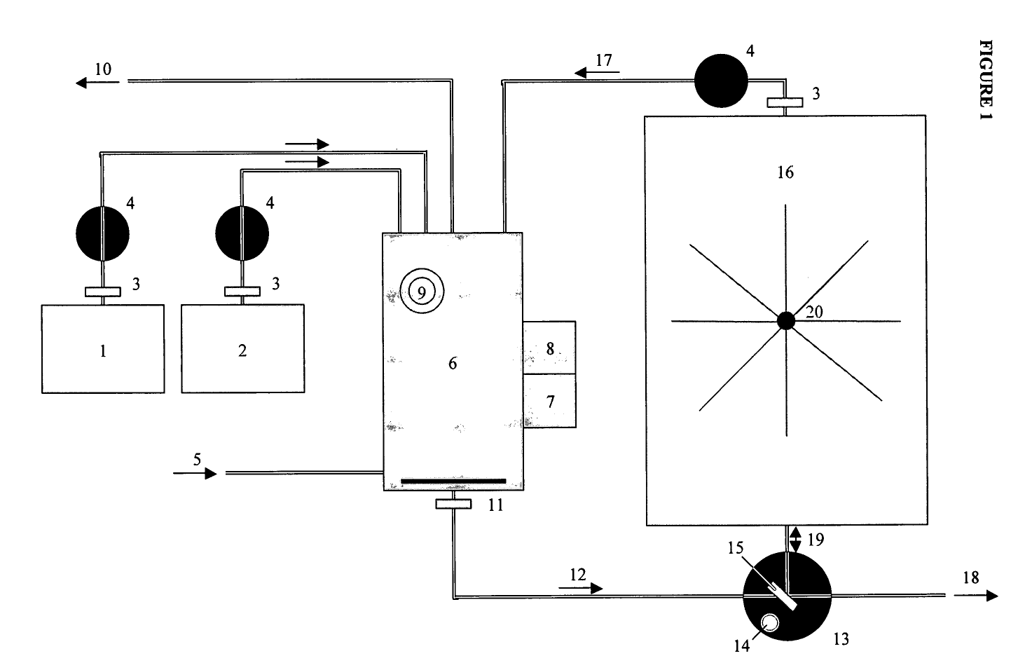

According to the present invention, there is also provided apparatus for dispensing liquid at a desired flow rate (see FIG. 1), comprising a metering pump (13) with variable speed adjustment (14), said metering pump connected to a weigh vessel (6) that measures the weight of its contents at least one time per minute, said weigh vessel connected to a processing unit (7) for converting the weight and time information measured by the weigh vessel into a flow rate, and the processing unit connected to a display unit (8) for outputting said flow rate, wherein the speed of the metering pump (13) can be adjusted to achieve the desired flow rate.

The speed of the metering pump can be increased or decreased using a speed dial (14). The flow rate may be displayed via any conventional means, for example via an analogue or digital display (8). The flow rate may be output in any unit of measurement that reflects the change in weight per unit time. Preferably, the flow rate is calculated in pounds per minute.

Liquids can be pumped into the apparatus directly from containers 1 and 2. When using the apparatus to dispense agrochemicals, 1 and 2 may be totes in which the chemicals are supplied. Each liquid can be pumped into the apparatus in turn, and the desired amount of each liquid can be accurately measured using the weigh vessel. Water can be added via the inlet tube (5). The weight of water can also be accurately measured using the weigh vessel. Once the desired weight of liquid is present in the weigh vessel (6), it is pumped into a mix tank (16). The mix tank (16) comprises a means for thorough mixing of liquids (20). Mixing may be achieved by any conventional means, for example, by agitation, stirring or pumping.

The weigh vessel comprises an overflow tube (10). Preferably the overflow tube is transparent to facilitate detection that the weigh vessel is full. The weigh vessel may additionally comprise a sensor that automatically deactivates the inlet pumps (4) when the weigh vessel is full.

The apparatus comprises an outlet tube (18) through which liquid is pumped at the desired flow rate. The flow rate is controlled by the metering pump (13) and can be adjusted using the speed dial (14). The outlet tube may be connected to further components. For example when the apparatus is used for seed treatment, the outlet tube may be connected to a sprayer unit or chemical application head.

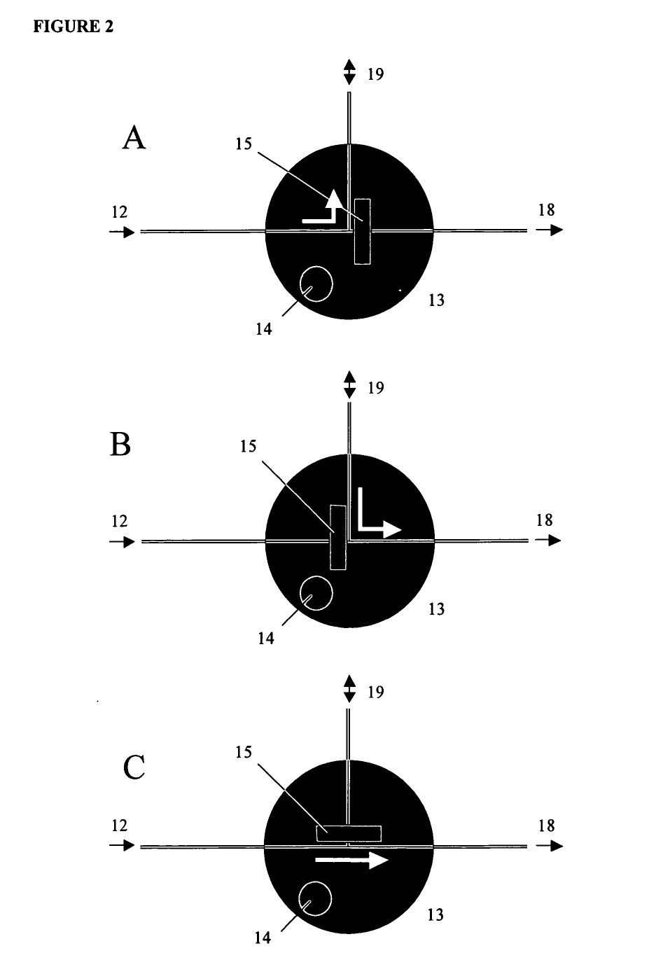

Direction of liquid flow pumped by the metering pump (13) is controlled by a 3-way process valve (15) (see FIG. 2). When the process valve is in position A, liquid is pumped from the weigh vessel (6) into the mix tank (16). When the process valve is in position B, liquid is pumped from the mix tank (16) to the outlet tube (18). When the process valve is in position C, liquid is pumped from the weigh vessel (6) to the outlet tube (18).

To set the flow rate of the metering pump (13), liquid is pumped into the weigh vessel from a tote (1 or 2), the water inlet (5) or the mix tank (16). Preferably the weigh vessel (6) is completely filled. The inlet pump (4) and/or water inlet (5) is then deactivated as appropriate. The display unit (8) is switched to flow mode. The weigh vessel drain valve (II) is opened and the metering pump (13) activated. The display unit outputs the flow rate of liquid based on the change in weight of liquid in the weigh vessel.

The apparatus and method of the present invention may be used to dispense any liquid where the flow rate needs to be controlled. One example is chemical(s) for use in agriculture. In particular, the apparatus and method of the present invention are useful for the treatment of seeds since it is important that the flow rate of agrochemical is correct to ensure adequate and even coverage of seeds. If too little chemical is applied, seeds will not be fully coated resulting in decreased efficacy. If too much chemical is applied, expensive chemicals are wasted and the costs can be high.

When pumping an agrochemical slurry mix, it is preferable to set the flow rate using the slurry itself to take account of the viscosity of the liquid. When setting the flow rate, slurry mix is pumped from the mix tank (16) to the weigh vessel (6) through tube 17. The flow rate is set using the process described above, except that the process valve (15) should be in position A so that the slurry mix is recycled back to the mix tank (16) rather than wasted. Once the speed dial (14) of the metering pump (13) has been adjusted to give the correct flow rate, the process valve (15) is moved to position B so that slurry mix is pumped from the mix tank (16) to the outlet tube (18). To check the flow rate without interrupting liquid flow through the outlet tube (18), first liquid is pumped from the mix tank to the weigh vessel through tube 17. This can be done without deactivating the metering pump (13). The process valve (15) is then moved to position C so that liquid is pumped from the weigh vessel directly to the outlet tube (18). The flow rate is output to the display unit (8), and can be adjusted during operation. After checking and if necessary adjusting the flow rate, the process valve (15) is returned to position B.

In one embodiment of the invention, the flow rate is output to the display unit in real time so that adjustments in metering pump speed can be observed immediately on the display unit. In this context, ‘real time’ means a near instantaneous display of the flow rate that is calculated and updated continuously. For example, the flow rate reading on the display unit may be updated approximately every 3 seconds. In this way, changes in the flow rate, such as those made by adjusting the speed of the metering pump, can be observed almost immediately.

In a further embodiment of the invention, the apparatus is a closed system that can be operated without human exposure to the liquid to be dispensed. This is particularly useful to enable potentially dangerous chemicals to be diluted, mixed and dispensed safely.

In another embodiment of the invention, the weigh vessel (6) contains a rinsing device (9) that spins inside the vessel when liquid is present, such as when water is introduced into the weigh vessel, so that the inner walls of the vessel can be cleaned without disassembly of the apparatus. Preferably, water is used to clean the inside of the weigh vessel. Accordingly, human exposure to the liquid to be dispensed is further minimised by this feature that allows the inside of the weigh vessel (6) to be rinsed without disassembly of the apparatus.

In one aspect of the invention the weigh vessel (6) measures the weight of its contents at least 1 time per 30 seconds. In another aspect of the invention the weigh vessel (6) measures the weight of its contents at least 1 time per 10 seconds. In a further aspect of the invention the weigh vessel (6) measures the weight of its contents at least 1 time per 5 seconds. In one aspect of the invention the weigh vessel (6) measures the weight of its contents at least 1 time per second. In a further aspect of the invention the weigh vessel measures the weight of its contents at least 5 times per second. In a still further aspect of the invention the weigh vessel measures the weight of its contents at least 10 times per second. A processing unit (7) converts the weight and time measurements into the flow rate which is subsequently displayed on a display unit (8).

In one embodiment of the invention, the liquid to be dispensed is a slurry comprising at least one agrochemical. In a further embodiment, the liquid or slurry comprises an insecticide and/or a fungicide. The liquid or slurry may comprise, for example, Cruiser™ insecticide, Dynasty™ fungicide, and/or Avicta™ nematicide.

According to the present invention, there is provided the use of the apparatus described above for the treatment of seeds with agrochemicals. Seeds of any plant species may be treated using the apparatus and method of the present invention. Particularly suited are seeds that are routinely treated prior to sowing. In one embodiment of the invention, the apparatus is used for the treatment of soybean seeds with Cruiser™ insecticide.

FIG. 1 is a schematic diagram that illustrates how the components of the apparatus are connected.

FIG. 2 is a schematic diagram that illustrates the operation of the 3-way process valve.

The white arrows indicate the direction of liquid flow between the weigh vessel (via 12), the outlet tube (via 18) and the mix tank (via 19) depending on the position of the process valve (15).

### EXAMPLES

### Example 1

### Making a Slurry Mix

It is first necessary to calculate the amount of each product required in the slurry mix. For example, to treat 40 units of soybean seed with Cruiser™ insecticide and ApronMaxx™ fungicide, the following components are required:
30 fl oz or 2.44 lb of Cruiser™ 5FS
35 fl oz or 2.45 lb of ApronMaxx™ RFC
52 fl oz or 3.39 lb of water

This makes a slurry that will be applied at a rate of 5 fl oz/cwt of seed. Totes (1 and 2) containing the agrochemicals Cruiser™ 5FS and ApronMaxx™ RFC are connected to the apparatus using dry lock fittings.

The display unit (8) is set to ‘weigh’ mode to enable the amount of each component to be measured. Firstly, part of the water (for example 1 lb) is added to wet the tank and hoses. To do this, the weigh vessel drain valve (11) is closed, and water is added to the weigh vessel (6) until the display unit (8) reads 1 lb. The weigh vessel drain valve (11) is then opened to allow the water to empty into the mix tank (16). The mix tank agitation (20) must be active whenever there is product in the mix tank. Next, the Cruiser™ 5FS is added using the same process. This is controlled using the dispense valve (3) for the tote (1) containing the Cruiser™ insecticide. Once the Cruiser™ has been added into the mix tank, the ApronMaxx™ is added from the second tote (2) using the same process. When all the products are added to the mix tank, the rest of the water is added, again using the same process. As well as diluting the agrochemicals to the correct working concentration, water is added at the end to rinse down the inside of the weigh vessel.

### Example 2

### Calibrating the Metering Pump

The mixed slurry is pumped into the weigh vessel (6) until slurry begins to flow down the overflow tube (10). This indicates that the weigh vessel is full. The pump (4) is then shut off. The display unit (8) is adjusted from ‘weigh’ mode to ‘flow’ mode to enable calibration of the metering pump (13). The flow mode is used to calibrate the metering pump since it displays the rate at which the slurry is being pumped in lb/min.

The process valve (15) is moved to position B, and the metering pump (13) is activated. The pump speed is adjusted using the speed dial (14) until the desired flow rate is obtained. To calculate the desired flow rate for this example, the following calculation is made:
7.27 cwt seed/min×5 fl oz Cruiser™/cwt=36 fl oz slurry/min required to treat the seed. This is equivalent to 2.58 lb/min.

### Example 3

### Seed Treatment

The 3-way process valve (15) is turned from position A to position B. The metering pump speed dial (14) is maintained at the setting calibrated in Example 2 above. The metering pump (13) is activated to supply agrochemical slurry to the seed treater via the outlet tube (18).

Optionally, the seed treatment equipment may be designed to be activated automatically when seed is present in the surge hopper. In this case, the metering pump (13) can be connected to the system so that when seed touches the sensor in the surge hopper, the system activates and the metering pump (13) starts automatically.

We claim:

1. A method for dispensing liquid at a desired flow rate, comprising:
a) partially or completely filling a weigh vessel with liquid to be dispensed,
b) activating a metering pump to pump the liquid out of the weigh vessel, and
c) adjusting the speed of the metering pump to the desired flow rate,
wherein the weigh vessel measures the weight of its contents at least one time per minute, a processing unit converts this information into the flow rate, and a display unit outputs the flow rate.

2. Apparatus for dispensing liquid at a desired flow rate, comprising
a) a metering pump with variable speed adjustment, connected to
b) a weigh vessel that measures the weight of its contents at least one time per minute, said weigh vessel connected to
c) a processing unit for converting the information from step b) into a flow rate, and the processing using connected to
d) a display unit for outputting said flow rate,
wherein the speed of the metering pump can be adjusted to achieve the desired flow rate.

3. Apparatus according to claim 2, wherein the flow rate is output to the display unit in real-time so that adjustments in metering pump speed can be observed immediately on the display unit.

4. Apparatus according to claim 2, wherein said apparatus is a closed system that can be operated without human exposure to the liquid to be dispensed.

5. Apparatus according to claim 2, wherein the weigh vessel contains a rinsing device that spins under water pressure so that the inside of the vessel can be cleaned without disassembly of the apparatus.

6. A method according to claim 1, wherein the weigh vessel measures the weight of its contents at least 1 time per 10 seconds.

7. A method according to claim 1, wherein the weigh vessel measures the weight of its contents at least 1 time per second.

8. A method according to claim 1, wherein the liquid is a slurry comprising at least one agrochemical.

9. A method according to claim 1, wherein the liquid comprises an insecticide and/or a fungicide.

10. An apparatus according to claim 2, wherein the weigh vessel measures the weight of its contents at least 1 times per 10 seconds.

11. An apparatus according to claim 2, wherein the weigh vessel measures the weight of its contents at least 1 time per second.

12. An apparatus according to claim 2, wherein the liquid is a slurry comprising at least one agrochemical.

13. An apparatus according to claim 2, wherein the liquid comprises an insecticide and/or a fungicide.
